(19) United States
(12) Patent Application Publication
(10) Pub. No.: US 2014/0064051 A1
(43) Pub. Date: Mar. 6, 2014

(54) DISC PLAYER AND COMMUNICATION METHOD

(71) Applicants: HONG FU JIN PRECISION INDUSTRY (ShenZhen) CO., LTD., (US); HON HAI PRECISION INDUSTRY CO., LTD., New Taipei (TW)

(72) Inventors: BING ZHOU, Shenzhen (CN); JUN LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/866,186

(22) Filed: Apr. 19, 2013

(30) Foreign Application Priority Data
Aug. 31, 2012 (CN) 2012103173889

(51) Int. Cl. G11B 20/18

(52) U.S. Cl. CPC G11B 20/1816
USPC 369/53.44

(57) ABSTRACT

A communication method is executed by a disc player to communicate with an external device. The disc player loads and reads a plurality of test discs. The disc player includes an audio interface, and a video interface. The communication method includes steps of: reading a loaded test disc to generate test information; determining whether the disc player successfully reads the loaded test disc based on the test information; and generating and transmits a test signal to the external device via one of the audio interface and the video interface based on the determined result, for controlling the external device to assist the disc player to complete the test.

### BACKGROUND

1. Technical Field

The present disclosure relates to disc players, particular to a communication method for the disc player.

2. Description of Related Art

A disc player, such as a digital video disc (DVD) player, includes an audio and a video interfaces. When the DVD player has been manufactured, the DVD player needs to be tested to determine that whether the DVD player satisfies predetermined and expected standards. The DVD player does not contain communication interfaces to communicate with automatic testing equipment and needs to be tested manually. The manual test method is time consuming.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a function block diagram of a disc player having a test unit in accordance with an embodiment.

FIG. 2 is a function block diagram of the test unit in FIG. 1.

FIG. 3 is a flowing chart of a communication control method in accordance with an embodiment.

### DETAILED DESCRIPTION

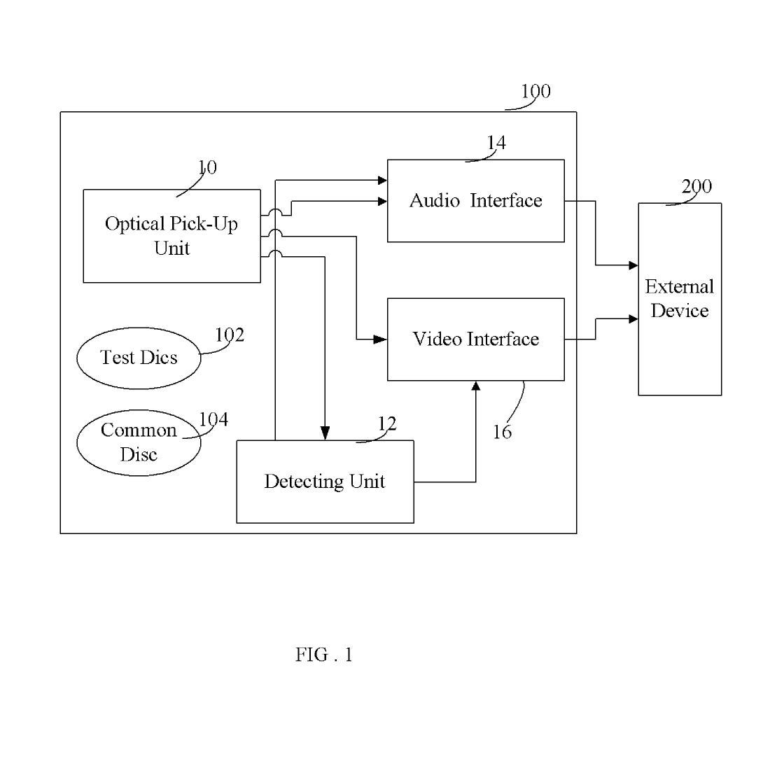

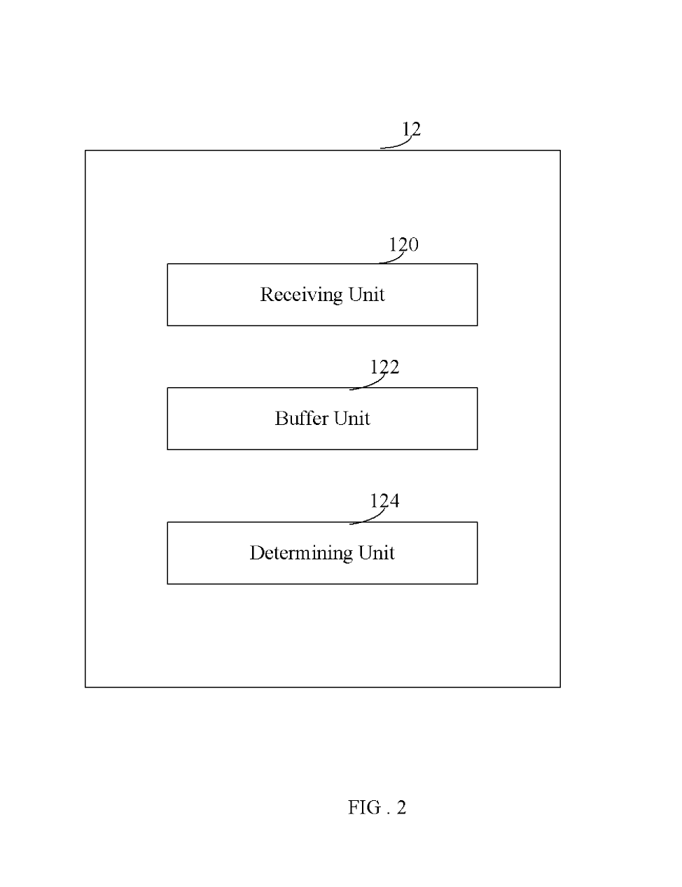

FIGS. 1 and 2 show an embodiment of a disc player 100 used for communicating with an external device 200. The disc player 100 needs to read a plurality of test discs 102 for testing the functions of the disc player. The disc player 100 also can read a common disc 104 to produce audio and video signal of the common disc 104. The test discs 102 record videos. The external device 200 can provide the test disc 102 one by one for the disc player 100.

The disc player 100 includes an optical pick up unit 10, a detecting unit 12, an audio output interface 14, and a video output interface 16. The audio output interface 14 and the video output interface 16 are electronically connected to the external device 200.

When the disc player 100 needs to be tested, one test disc at a time is loaded. The optical pick up unit 10 reads the loaded test discs 102 and generates test information in response to an operation of a user. The detecting unit 12 determines whether the optical pick up unit 10 successfully reads the loaded test disc 102 or fails to read the loaded test disc 102 based on the test information. The detecting unit 12 further generates a first audio signal and transmits the first audio signal to the external device 20 via the audio interface 14 when the optical pick up unit 10 successfully reads the loaded test disc 102. The detecting unit 12 further generates a second audio signal and transmits the second audio signal to the external device 20 via the audio interface 14 when the optical pick up unit 10 fails to read the loaded test disc 102. In the embodiment, a frequency of the first audio signal is 1 kHz, a frequency of the second audio signal is 2 kHz. The method for the detecting unit 12 to generate the first audio signal and the second audio signal will be described below.

FIG. 2 shows that the detecting unit 12 includes a receiving unit 120, a buffer unit 122, and a determining unit 124.

The receiving unit 120 receives images read by the optical pick up unit 120 from the test disc 102. In particular, the optical pick up unit 120 reads a few images or no images when the optical pick up unit 120 fails to read the test disc 102 to make the disc player 100 pauses.

The buffer unit 122 temporarily stores the received images.

The determining unit 124 determines whether the number of the received images stored in the buffer unit 122 reaches a predetermined number after the optical pick up unit 10 reads the test disc 102 for a predetermined period. The determining unit 124 generates the first audio signal when the number of the received images reaches the predetermined number, and generates the second audio signal when the number of the received images does not reach the predetermined number. In another embodiment, the determining unit 124 determines whether the number of the images stored in the buffer unit 122 every hour reaches a predetermined number after the optical pick up unit 10 reads the test disc 102 for a predetermined period.

The external device 200 replaces the loaded test disc 102 with a different test disc 102, in response to the first audio signal. The external device 200 controls the loaded test disc 102 to eject from the disc player 100 in response to the second audio signal.

In another embodiment, the first audio signal and the second audio signal can be a first video signal and a different second video signal, and transmitted to the external device 200 via the video interface 16. In particularly, the first video signal can be reproduced as a single color image and a second video signal can be reproduced as another single color image which is different from the first signal color image.

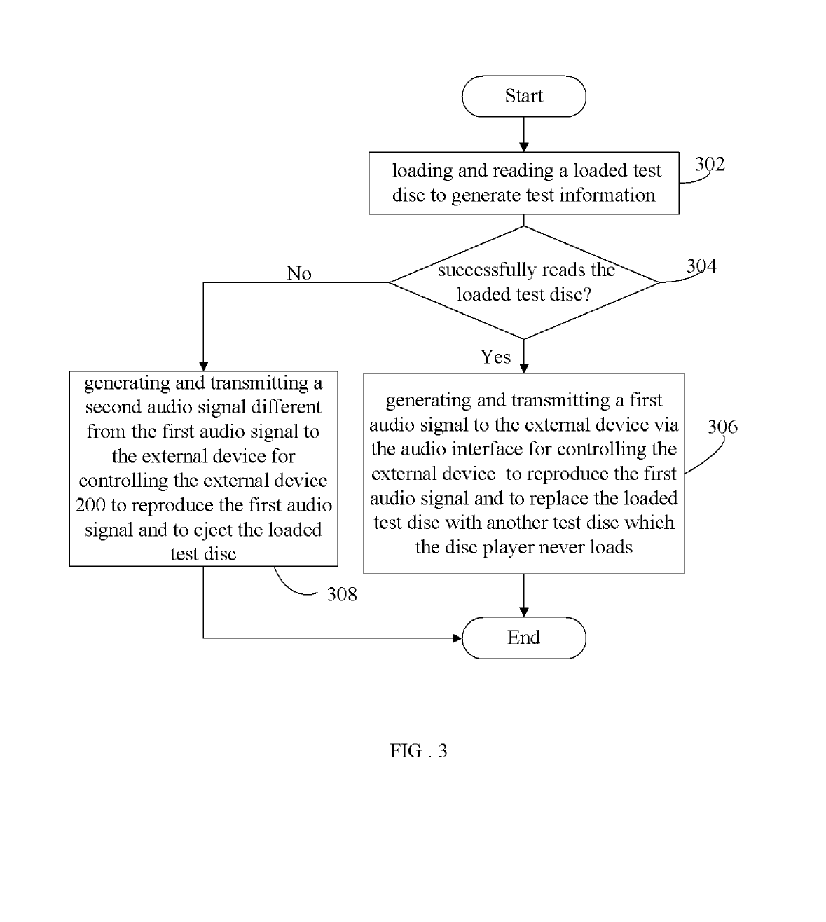

FIG. 3 shows that a communication method applied to the disc player 100 enables the disc player 100 to communicate with the external device 200.

In step 302, loading and reading a test disc to generate test information by the disc player.

In step 304, determining whether the disc player 100 successfully reads or fails to read the loaded test disc. When the disc player 100 successfully reads the loaded disc, the process goes to step 306. When the disc player 100 fails to read the loaded disc, the process goes to step 308. In particularly, step 304 further includes the steps of: determining whether the number of the images reproduced reaches a predetermined number after the disc player reads the loaded test for a predetermined period. When the determined number of the images reproduced reaches a predetermined number after the optical pick up unit reads the loaded test for a predetermined period, it is determined that the disc player successfully reads the loaded test disc. If the determined number of the images reproduced does not reach the predetermined number after the optical pick up unit reads the loaded test disc for the predetermined period, it is determined that the disc player displayer fails to read the loaded test disc.

In step 306, generating and transmitting a first audio signal to the external device 200 via the audio interface for controlling the external device 200 to reproduce the first audio signal and to replace the loaded test disc with another test disc, which is not loaded in the disc player.

In step 308, generating and transmitting a second audio signal different from the first audio signal to the external device for controlling the external device 200 to reproduce the first audio signal and to eject the loaded test disc.

In another embodiment, the first audio signal and the second audio signal can be a first video signal and a different second video signal. The first video signal and the second video signal are transmitted to the external device 200 via the video interface 16 for controlling the external device 200 to replace the loaded test disc with another test disc or for ejecting the loaded disc. Therefore, the external device 200 can assist the disc player 100 to complete the test for determining whether the disc player 100 satisfies predetermined and expected standards.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A disc player, communicating with an external device to test the disc player, the disc player needing to load a plurality of test discs to perform the test, the disc player comprising:
an audio interface;
a video interface;
an optical pick up unit to read a loaded test disc to generate test information; and
a detecting unit to determined whether the optical pick unit successfully reads the loaded test disc based on the test information;
wherein the detecting unit generates and transmits a test signal to the external device via one of the audio interface and the video interface based on the determined result, for controlling the external device to assist the disc player in completing the test.

2. The disc player of claim 1, wherein the test signal is one of a first audio signal and a second audio signal, the first audio signal is generated and transmitted to the external device via the audio interface when the optical pick up unit successfully reads the loaded test disc; the second audio signal is generated and transmitted to the external device when the optical pick up unit fails to read the loaded test disc; the external device replaces the loaded test disc with another test disc different from the loaded disc in response to the first audio signal, the external device controls the loaded test disc to eject from the disc player in response to the second audio signal.

3. The disc player of claim 2, wherein a frequency of the first audio signal is 1 kHz, a frequency of the second audio signal is 2 kHz.

4. The disc player of claim 2, wherein the first audio signal and the second audio signal is reproduced by the external device when the one of the first audio signal and the second audio signal is transmitted to the external device.

5. The disc player of claim 1, wherein the test signal is one of a first video signal and a second video signal, the first video signal is generated and transmitted to the external device via the video interface when the optical pick up unit successfully reads the loaded test disc; the second video signal is generated and transmitted to the external device when the optical pick up unit fails to read the loaded test disc; the external device replaces the loaded test disc with another test disc different from the loaded test disc in the disc player in response to the first video signal, the external device controls the loaded test disc to eject from the disc player in response to the second video signal.

6. The disc player of claim 5, wherein the first video signal and the second video signal are reproduced as different color images.

7. The disc player of claim 5, wherein one of the first video signal and the second video signal is reproduced by the external device when the one of the first video signal and the second video signal is transmitted to the external device.

8. The disc player of claim 1, wherein the loaded test disc records video, the test information is images reproduced from the loaded test disc by the optical pick up unit, the detecting unit receives the images from the optical pick up unit and determines whether the number of the images from the optical pick up unit reaches a predetermined number after the optical pick up unit reads the loaded test for a predetermined period, when the number of the images reaches the predetermined number, the optical pick up unit successfully reads the loaded test disc, when the number of the images does not reach the predetermined number, the optical pick up unit fails to read the loaded test disc.

9. A communication method, executed by a disc player to communicate with an external device to test the disc player, the disc player needing to load and read a plurality of test discs, the disc player comprising an audio interface, and a video interface, the communication method comprising:
reading a loaded test disc to generate test information;
determining whether the disc player successfully reads the loaded test disc based on the test information; and
generating and transmitting a test signal to the external device via one of the audio interface and the video interface based on the determined result, for controlling the external device to assist the disc player in completing the test.

10. The communication method of claim 9, wherein the test signal is one of a first audio signal and a second audio signal, the first audio signal is generated and transmitted to the external device via the audio interface when the disc player successfully reads the loaded test disc; the second audio signal is generated and transmitted to the external device when the disc player fails to read the loaded test disc; the external device replaces the loaded test disc with another test disc different from the loaded test disc in response to the first audio signal, the external device controls the loaded test disc to eject from the disc player in response to the second audio signal.

11. The communication method of claim 10, wherein a frequency of the first audio signal is 1 kHz, a frequency of the second audio signal is 2 kHz.

12. The communication method of claim 11, wherein one of the first audio signal and the second audio signal is reproduced by the external device when the one of the first audio signal and the second audio signal is transmitted to the external device.

13. The communication method of claim 11, wherein the test signal is one of a first video signal and a second video signal, the first video signal is generated and transmitted to the external device via the video interface when disc player successfully reads the loaded test disc; the second video signal is generated and transmitted to the external device when the disc player fails to read the loaded test disc; the external device replaces the loaded test disc with another test disc different from the loaded test disc in response to the first video signal, the external device controls the loaded test disc to be ejected from the disc player in response to the second video signal.

14. The communication method of claim 13, wherein the first video signal and the second video signal are reproduced as different color images.

15. The communication method of claim 13, wherein one of the first video signal and the second video signal is reproduced by the external device when the one of the first video signal and the second video signal is transmitted to the external device.

16. The communication method of claim 13, wherein the loaded test disc records video, the disc player reproduce a plurality of images from the loaded test disc, the step of determining whether the disc player displayer successfully reads or fails to read the loaded test disc based on the test information comprises steps of:
determining whether the number of the images reproduced reaches a predetermined number after the disc player reads the loaded test for a predetermined period, when the number of the images reproduced reaches a predetermined number after the optical pick up unit reads the loaded test for a predetermined period, it is determined that the disc player successfully reads the loaded test disc; and
when the number of the images reproduced does not reach the predetermined number after the optical pick up unit reads the loaded test for the predetermined period, it is determined that the disc player displayer fails to read the loaded test disc.
